(19) United States
(12) Patent Application Publication
(10) Pub. No.: US 2025/0326169 A1
(43) Pub. Date: Oct. 23, 2025

(54) COMPACT INJECTION MOULD FOR A CAP WHICH IS PREFERABLY PROVIDED WITH AN APPLICATOR SHAFT

(71) Applicant: GEKA GmbH, Bechhofen (DE)

(72) Inventor: Tobias GUEMPELEIN, Bechhofen (DE)

(21) Appl. No.: 18/719,195

(22) PCT Filed: Dec. 13, 2022
(86) PCT No.: PCT/EP2022/085674

§ 371 Date: Feb. 28, 2025

(30) Foreign Application Priority Data
Dec. 13, 2021 (DE) 10 2021 214 261.3

(51) Int. Cl. B29C 45/44; B29C 45/17; B29L 31/56

(52) U.S. Cl. CPC B29C 45/44; B29C 45/1775; B29C 2045/4485; B29L 2031/565

(57) ABSTRACT

An injection molding tool includes a \ primary mold cavity forming a handle sleeve having an inner circumference with an integral transition section attached thereto, and transitioning into a shaft protruding from the handle sleeve. The handle sleeve in an area between the attachment of the transition section and a free end facing the free end of the shaft has a skirt with an internally formed fastener for securing the handle sleeve to a container. The injection molding tool has an ejector-side insert and a nozzle-side insert removable for demolding purposes. The nozzle-side insert provides the part of the main mold cavity that molds the outer circumference of the handle sleeve, and the ejector-side insert.

### CROSS REFERENCE

This application is a U.S. national stage application of International Application No. PCT/EP2022/085674, filed on Dec. 13, 2022, which claims priority to German Patent Application No. 102021214261.3, which was filed on Dec. 13, 2021, the contents of each of which are hereby incorporated by reference.

### BACKGROUND

### Technical Field

The disclosure relates to an injection molding tool equipped with a special main form cavity.

Background Information Injection molding tools are already known from practice that are equipped in such a way that a cap that can be fixed on a container can be injection molded with a shaft that either already forms an applicator itself or that can be fitted with an applicator.

### SUMMARY

it has been determined that injection molding tools known so far consistently require long slide strokes or demolding strokes for the purpose of shaping the parts produced with their help.

As a result, the known injection molds tend to be quite bulky, particularly in the longitudinal direction, that is, in the direction of the central or rotational symmetry axis of the shaft. This makes the molds cumbersome and increases their cost. Moreover, the main problem is that operating such molds requires larger injection molding machines than what is actually necessary for the injection process itself.

Accordingly, the objective of the disclosure is to create an injection molding tool that can be built more compactly.

The solution according to the disclosure is achieved by an injection molding tool with the features disclosed herein.

Accordingly, an injection molding tool for molding a cap that can be secured to a container is proposed, preferably with a shaft that either already forms an applicator itself, for example, with its fin-like flattened free end, or can be equipped with an applicator.

In its injection-ready closed state, the injection molding tool has a form or main form cavity. This cavity shapes a grip sleeve. An integral transition section is connected to the inner circumferential surface of the grip sleeve. The transition section extends into a shaft, which protrudes from the grip sleeve, typically in the direction of the longitudinal axis L.

In this configuration, the grip sleeve features a skirt in the area between the connection of the transition section and its free end facing the free end of the shaft. On its inner side, this skirt is equipped with a fastening means for securing the grip sleeve to a container.

In this configuration, the injection molding tool comprises an ejector-side insert and a nozzle-side insert, which can be removed for the purpose of demolding.

According to the disclosure, the injection molding tool is characterized by the fact that the nozzle-side insert essentially provides the part of the mold cavity that shapes the outer circumferential surface of the grip sleeve.

At the same time, the ejector-side insert-if given, through one or more slides guided by it-essentially provides the part of the mold cavity that shapes the shaft, if present. In any case, the slide running in the ejector-side insert forms the bayonet lock or the thread on the grip sleeve.

Finally, the injection molding tool is designed such that the mold cavity, which shapes the grip sleeve, extends into the ejector-side insert.

In this context, the term “insert” has a broader and a narrower meaning. In its preferred narrower sense, the term “insert” refers to a replaceable part that can be inserted into a corresponding plate arrangement of an injection molding tool to adapt the universally applicable injection molding tool for molding a specific component.

In its non-preferred but possible broader sense, the term “insert” also refers to correspondingly shaped plates; that is, the insert in the narrower sense and the plates holding it are then integrally formed as a single piece.

The mold cavity is the cavity into which the plastic to be processed in an originally forming manner by injection molding is injected to form the desired workpiece when cooled. Functionally, the form cavity can be divided into a main form cavity and at least one undercut form sub-cavity. The latter is represented using a radial slide.

The longitudinal axis L is defined as the central longitudinal axis L that is predetermined by the grip sleeve.

The following can be said about the term essentially, used in the main claim itself:

The nozzle-side insert preferably represents at least 75%, preferably at least 80%, and ideally at least 85% of the mold cavity or the mold cavity portion that shapes the grip sleeve. This means that only a correspondingly small portion of the mold cavity or the mold cavity portion is represented by the ejector-side insert of the injection molding tool, including the radial slide(s) forming part of it.

In this way, a significant contribution can be made to ensure that the injection molding tool can be built particularly short/narrow in the direction of the longitudinal axis and transverse to the longitudinal axis.

Preferably, the ejector-side insert features at least one radial slide, ideally fully recessed and movably guided within a groove of the ejector-side insert. This radial slide preferably has a pin, strip, or cuboid-like structure, meaning it is only locally limited involved in the formation of the mold cavity. It forms an undercut sub-cavity connected to the main mold cavity to create an undercut structure on the grip sleeve in the direction of the longitudinal axis L.

Preferably, the radial slide has a cutout bordered inclined to the longitudinal axis of the mold. In this cutout, when the injection molding tool is closed, a chamfered actuation extension of a radial slide actuation/blocking mechanism can engage. Typically, the chamfers are designed so that the actuation extension lifts the radial slide in a radial outward direction when the nozzle-side insert is lifted from the ejector-side insert during demolding.

Conversely, the actuation extension also pushes the radial slide back into its radially inward closed position when the nozzle-side insert is placed onto the ejector-side insert during the re-closing process. In this way, there is no need for an additional radial slide drive. Instead, the radial slides are forcibly controlled from the side that carries or forms the nozzle-side insert, in a very simple manner.

Another objective is to provide simple and thus very compact means by which the core, which forms the fastening means for securing the grip sleeve to a container, can be easily pulled.

The solution according to the disclosure is achieved by an injection molding tool with the features of the second main claim, which, optionally, also unfolds its synergistic effect as a dependent claim under the first main claim. As for the generic part of the second main claim, the above applies correspondingly which was said with respect to the first main claim.

Furthermore, this second injection molding tool according to the disclosure is characterized by the presence of a rotatable screw core in its ejector-side insert. This core forms a thread on the inner side of the skirt. The screw core is supported in a defined position via an end-thread formed on it, which is held in the counter-thread of a guide nut.

In this setup, the threaded drive formed between the guide nut and the screw core is a synchronous threaded drive, such that the screw core is forced deeper into the guide nut by a rotational movement imposed on it during molding and it simultaneously rotates out of the thread on the inner side of the skirt to the same extent and thus free from tension.

This creates a very space-saving mechanism for molding the core in the direction of the longitudinal axis, which forms the internal thread on the skirt of the grip sleeve.

Ideally, the bearing of the rotatable screw core does not include a roller bearing, which is cost-effective and, above all, helps to save space.

Preferably, the synchronous threaded drive is designed in such a way that it can be used to adjust at what height along the longitudinal axis the thread on the inner side of the skirt begins and in what rotational position.

Preferably, the guide nut, in turn, is forcibly rotatable in the injection molding tool, preferably by means of a circumferential gear attached to it. Such a guide nut, by stepwise or stepless setting of its rotational position, can contribute to adjusting and defining the positioning and alignment of the thread on the inner side of the skirt.

### BRIEF DESCRIPTION OF THE DRAWINGS

Referring now to the attached drawings which form a part of this original disclosure, illustrative embodiments are shown.

FIG. 1 shows an overall view of an injection molding tool according to the disclosure in longitudinal section.

FIG. 2 shows all components essential for cavity formation and shaping in the embodiment according to FIG. 1, in isolated representation, immediately after the injection of the plastic material to be originally formed.

FIG. 3 shows all components essential for cavity formation and shaping in the embodiment according to FIG. 1, in isolated representation, during the forming process, after solidification.

FIG. 4 shows a magnified section of FIG. 3 to provide a more detailed visualization of the workpiece produced using the injection molding tool according to the disclosure.

FIG. 5 is a top perspective view of the radial slider.

FIG. 6 essentially shows the same as FIG. 4 but additionally reveals the undercut structure created by the sub-cavity formed by a radial slide.

### DETAILED DESCRIPTION

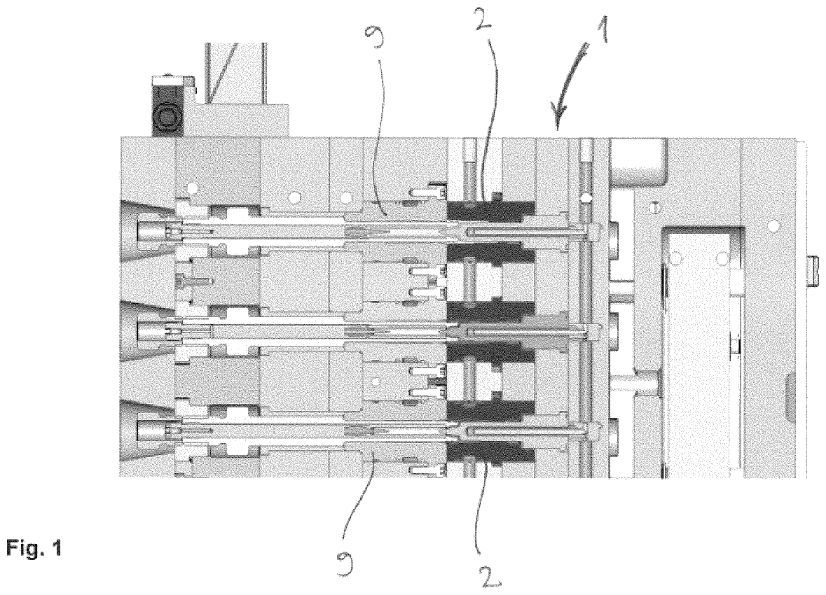

FIG. 1 provides an overall view of an injection molding tool 1 according to the disclosure, using the preferred example of a cosmetic applicator. It should be noted, however, that an applicator for other purposes can be designed and manufactured in the same way.

This injection molding tool 1 is equipped to manufacture a cap that can be securely attached to a container, with a shaft that either forms an applicator itself or can be equipped with one. The manufacturing process is carried out by injection molding. The injection molding tool depicted here is an example of a three-cavity injection molding tool, allowing three such caps to be molded at once. However, typically, it is preferred to use 8, 16, or even 32-cavity tools.

To achieve this, the injection molding tool 1 is equipped separately with a nozzle-side insert 2 and another ejector-side insert 9 for each cap to be molded. The term “nozzle-side” refers to the side from which the liquid plastic material is injected into the mold cavity. The term “ejector-side” refers to the side where the ejector is located, which ejects the molded cap from the injection molding tool 1.

As can be seen relatively well here, the injection molding tool 1 according to the disclosure is relatively compact in the longitudinal direction-that is, along the longitudinal axes L of the caps to be molded.

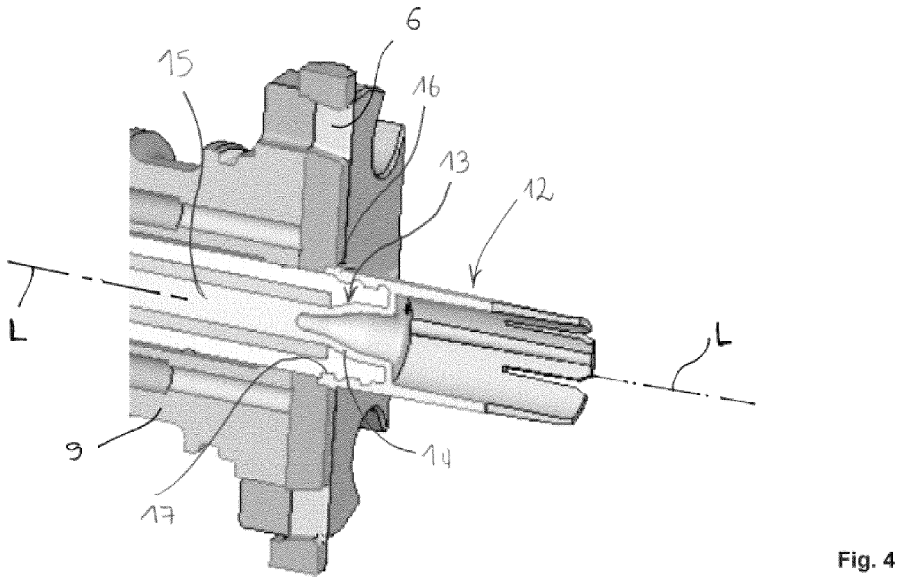

To understand the exact structure of the cap for which the injection molding tool according to the disclosure is designed for molding, it is best illustrated in FIG. 4.

The cap is represented, not least, by a grip sleeve 12. In many cases, the grip sleeve later carries a decorative cap, but it can also already form the finished decorative cap itself, which will remain visible later. Extending from the cap or the grip sleeve 12 is a shaft 15, which is shown truncated on the left side in FIG. 4. Additionally, a transition section 13 is provided, which connects the grip sleeve 12 to the shaft 15.

For this purpose, the transition section 13 is integrally connected to both the shaft 15 and the grip sleeve 12, in the area of its inner circumferential surface. Thereby the transition section 13 optionally forms a mostly internally hollow and therefore resilient sealing cone 14.

Alternatively, a flat gasket can be formed at the corresponding location, together with the seats required on both sides for it. This sealing cone 14 is designed to be pressed into a corresponding conical seat formed in the area of a container opening, such as a bottle neck, thereby sealing the respective container and preventing the cosmetic material stored in it from leaking unintentionally. The said conical seat is usually formed by a wiper, which is secured in the container neck.

Notably, the grip sleeve 12 forms a skirt 16 in the area between the connection of the transition section 13 and its end facing the free end of the shaft 15. This skirt 16 carries, on its inner circumferential surface, an integral fastening means (fastener) 17 for securing the grip sleeve to a container. The fastening means 17 is preferably, as here, a section-wise or continuously circumferential thread. It is worth noting, however, that alternatively, a bayonet lock can also be used effectively.

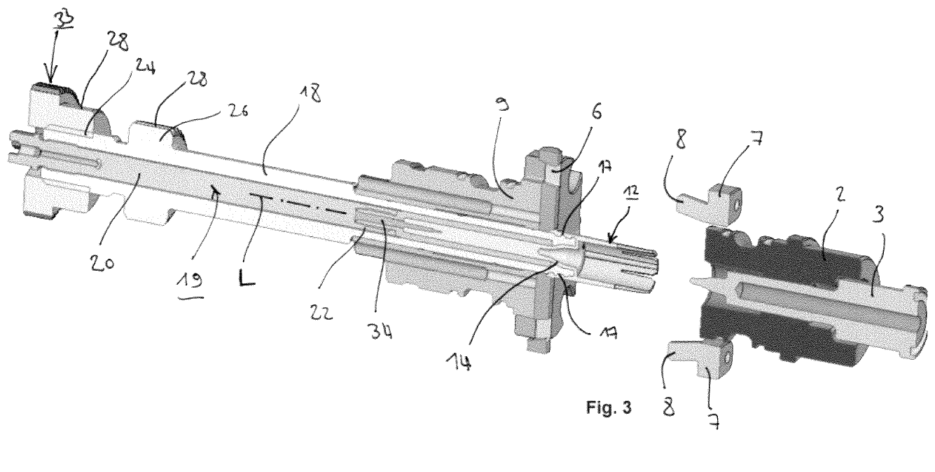

For the sake of completeness, it is worth mentioning that it is particularly advantageous if the grip sleeve 12 forms resilient tongues in the area of its end facing away from the shaft 15. These tongues facilitate or enable the assembly and securing of a decorative cap cover, as seen in FIG. 3.

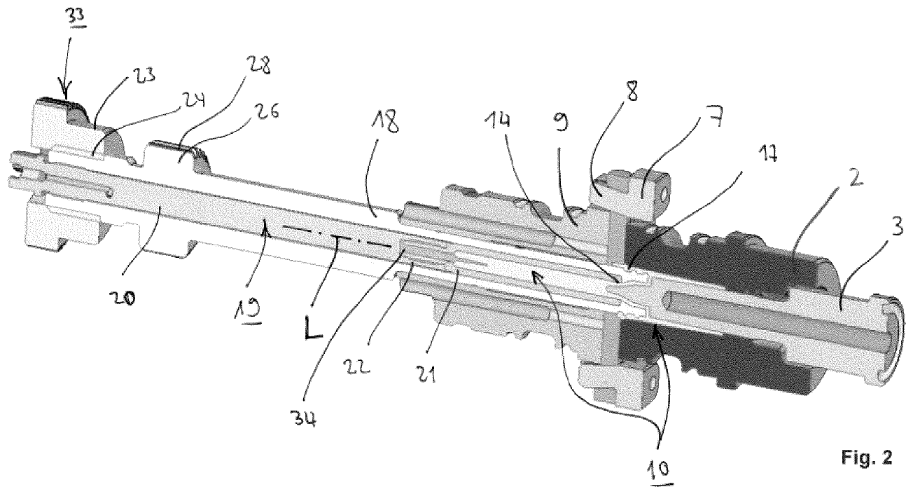

The further details can be well observed in FIGS. 2 and 3. These two figures show the relevant inserts and slides, which were already depicted in FIG. 1, enlarged and in a graphically extracted form from the injection molding tool 1.

FIG. 1 shows the crucial parts ready for the next injection molding process, i.e., in a tightly compressed position. These parts form the entire main mold cavity 10, which gives shape to a cap to be molded. Optionally, at least one auxiliary mold cavity 11 connected to the main mold cavity may also be provided, which will be discussed in more detail later.

It is easy to see the nozzle-side insert 2 again. Inside it, there is a nozzle-side core 3. This core represents the preferably predominant part of the cavity enclosed by the grip sleeve 12. If an optional sealing cone 14 is provided, as seen here, then the nozzle-side insert 2 or the core running inside it also forms the cavity enclosed by the sealing cone 14.

Also clearly visible is the ejector-side insert 9. In the present embodiment of the disclosure, the majority of its end face facing the nozzle side is in direct contact, providing a seal, with a corresponding end face of the nozzle-side insert 2.

The two inserts are pressed firmly against each other in such a way that there is no significant penetration of the initially thin plastic material injected during the injection molding process in the area of their parting line. Only a small, partially invisible to the naked eye, flash remains. This is due to the fact that the liquid plastic, under high pressure, can penetrate fractions of a millimeter into the initial area of the parting line.

As clearly visible here, according to the disclosure, the nozzle-side insert 2, although with the involvement of the corresponding slide, essentially provides the entire part of the main mold cavity that reproduces the grip sleeve 12.

Preferably, the main mold cavity extends from the nozzle-side insert 2 into the ejector-side insert 9, reaching its end area, which forms the annularly surrounding, free end face facing the shaft 15.

This ensures that the aforementioned parting line between the nozzle-side insert 2 and the ejector-side insert 9 is located all around the outer circumferential surface of the skirt 16 and does not coincide with the free end face of the skirt facing the shaft, as it would if it were to lie exactly in the plane where the aforementioned parting line is located all around.

The reason for this is that the formation of the here, albeit minimal, but still existing flash on the circumferential surface of the grip sleeve 12, usually crowned by a decorative cap, is much more tolerable than if such flash occurs on the always visible end ring face of the grip sleeve 12.

Optionally, the ejector-side insert 9 has at least one, or as seen in the example shown here, several grooves 5 to accommodate one radial slider 4 each. The grooves 5 are typically designed so that the radial slider 4 fits completely within them. This usually means that the radial slider 4 does not protrude beyond the surrounding end surface of the ejector-side insert 9.

Each of these radial sliders forms an undercut projection, viewed in the direction of the longitudinal axis L, which protrudes from the skirt 16 along the longitudinal axis L. This projection on the skirt 16 is illustrated in FIG. 6. As you can see, the mentioned undercut projection forms an L-shaped slot here, which exposes a resilient latch 31 and forms a protruding rotational stop 32.

This design is preferred. However, other undercut contours can be formed in the same manner, which is particularly advantageous.

When comparing FIGS. 2 and 6, it is easy to see how the radial slider 4 is structured.

At its radially inward end, it has a protrusion that forms the mentioned L-shaped slot or keeps it clear in the auxiliary mold cavity 11.

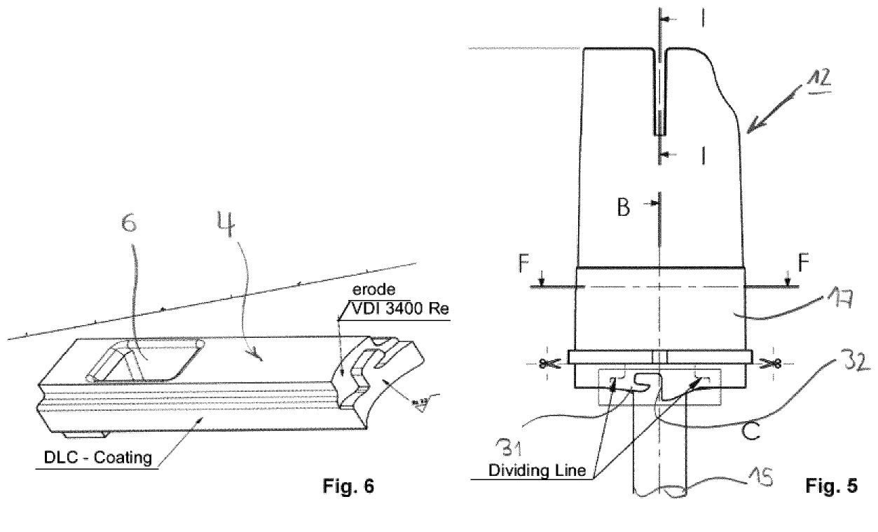

As seen in FIG. 5, the aperture 6 in the radial slider on its side facing away from the auxiliary cavity 11 is clearly visible. The aperture 6 serves to accommodate the actuation extension 8, which is formed on the radial slider lock 7, best seen in FIGS. 2 and 3.

As best seen in FIG. 4, the aperture 6 has a chamfered boundary wall on its radially inward side and on its respectively in any case radially outward side relative to the longitudinal axis L. Similarly, the actuation extension 8 of the radial slider lock 7 is correspondingly chamfered.

As can be clearly seen by comparing FIGS. 2 and 3, this results in the radial slider being lifted in the radially outward direction when the nozzle-side insert 2 is lifted from the ejector-side insert 9 for the purpose of forming.

It is particularly noticeable here how slender each of the mentioned radial sliders 4 is. Typically, each of the radial sliders has in its contour-forming area in the direction of the longitudinal axis L an extension that constitutes less than 50% and preferably less than 40% of the free length of the skirt 16. Outside the contour-forming area, different sizes of the radial slider may be present.

With regard to the inventive design, it is worth noting that inside the ejector-side insert 9, there is a slider, referred to as screw core 18. This engages with the interior of the skirt 16. It forms on the inner surface of the skirt 16 its inner fixing means (device) 17, usually in the form of a continuous or partially encountered threaded portion or internal threaded portion, or part of a bayonet closure, and the like.

The screw core 18 is guided in a corresponding bore in the center of the ejector-side insert 9. It is rotatably mounted relative to it. At its other end, opposite to the ejector-side insert 9, the screw core 18 carries a nut-side thread 25, preferably an external thread.

The screw core 18 is mounted with this in a lead nut 33 preferably made of bearing material, such as bearing bronze. This type of bearing using a thread replaces the at least one roller bearing otherwise required for the mounting of the screw core 18, which can according to the disclosure be completely omitted.

It is important that the lead screw thread 25 of the screw core 18 and the lead nut thread 24 form a synchronized thread drive with the thread drive that is created after the finished injection molding process between the nozzle end of the screw core 18 and the skirt 16 of the handle sleeve 12.

This means nothing other than that each rotation of the screw core 18 causes it to screw synchronously into the thread or internal thread of the lead nut 33, while it unscrews just as quickly from the threaded connection it has entered with the skirt 16 of the handle sleeve 12.

To impart the necessary rotational movement to the screw core 18, the screw core 18 carries a drive gear 26 at its end, preferably in the form of an externally and straight-toothed gear. This gear is driven by a rack (not shown here) moving transversely or perpendicularly to the longitudinal axis L.

This results in the required rotational movement for screwing the screw core 18 in and out. Due to the straight-toothed gearing and the use of open-flank racks, it does not matter that the drive gear 26 undergoes a displacement in and against the axial direction L during its operation. The drive gear 26 can slide accordingly on the racks (not shown) and then execute the necessary relative movement with respect to them.

It is notable that the guide nut 33 preferably also forms a drive wheel section 28, which in turn ideally carries an external gearing 29.

It is readily understandable that with this mechanism, the absolute position can also be adjusted at which height, in the axial direction, the beginning of the inner fastening means or thread formed on the inner circumferential surface of the skirt 16 lies.

It is noteworthy that the screw core 18 accommodates an axial core 19. This consists of the shaft rod 20 and a shaft sleeve 21 that can be fixed to it by the shaft thread connection 22. In this way, the injection mold can be quickly converted when differently designed caps are to be molded, which, for example, have a differently shaped shaft 15.

The shaft rod 20 is then essentially removed without disassembling the injection mold 1 by pulling it out on the end face of the injection mold opposite to the two inserts 2 and 9. Along with it, the shaft sleeve 21 is pulled out. It can now be replaced with another shaft sleeve 21 that reflects the currently needed shaft 15. If necessary, the shaft sleeve 21 can be provided with a different mandrel, which forms a retaining core 34 for an applicator insertion opening and determines how the receiving opening for an applicator in the shaft 15 is configured.

With all this, it may be interesting to design the retaining core 34 in a fundamentally different way. Namely in such a manner that the retaining core 34 passes completely through the shaft sleeve 21 at its end opposite to the shaft and also extends through the shaft rod 20, if it exists as a separate component. At the end opposite to the shaft side, the retaining core 34 then protrudes from the end face of the shaft rod 20.

This results in the shaft rod 20 and the shaft sleeve 21 being able to be rotated or unscrewed from their molding position during demolding without forcing the retaining core 34 to rotate with them. The applicator shaft can then be removed rotation-free from the retaining core 34. In this way, the retaining core can also depict non-circular applicator insertion openings.

1. An injection molding tool for injection molding a cap capable of being secured to a container, the injection molding tool, in a ready-to-mold state, comprising:
a main mold cavity that forms a grip sleeve,
integral to which an intermediate section is attached on an inner peripheral surface, transitioning into a shaft protruding from the grip sleeve,
the grip sleeve, in a region between attachment of the intermediate section and a free end facing a free end of the shaft, has a skirt with an internally formed fastener configured to secure the grip sleeve to a container; and
an ejector-side insert and a nozzle-side insert that are removable for molding;
the nozzle-side insert essentially provides a portion of the main mold cavity that forms the outer peripheral surface of the grip sleeve, and
the ejector-side insert essentially provides a portion of the main mold cavity that forms the shaft, the main mold cavity that forms the grip sleeve extending into the ejector-side insert.

2. The injection molding tool according to claim 1, wherein the ejector-side insert has at least one radial slider which is fully displaceably guided in a groove of the ejector-side insert and forms a secondary mold cavity for an undercut structure on the grip sleeve in a direction of a longitudinal axis.

3. The injection molding tool according to claim 2, wherein the radial slider has an opening bordered obliquely to the longitudinal axis of the mold, into which an angled actuating extension of a radial slider lock engages when the injection molding tool is closed, and bevels are configured such that the actuating extension lifts the radial slider when the nozzle-side insert is lifted off the ejector-side insert during demolding.

4. The injection molding tool, according to claim 1,
further comprising a rotatable screw core is arranged in the ejector-side insert, which forms an undercut holding contour, and is held by an end-side thread in a counter-thread of a guide nut, forming a thread drive between the guide nut and the screw core that is a synchronous thread drive, such that the screw core screws deeper into the guide nut through a rotational movement imposed thereon during demolding, thereby simultaneously unscrewing from the thread on an inner side of the skirt.

5. The injection molding tool according to claim 4, wherein the synchronous thread drive is configured to be adjust so as to determine a height along the longitudinal axis that the thread on the inner side of the skirt begins or in which rotational position.

6. The injection molding tool according to claim 4, the wherein mounting of the rotatable screw core does not include a rolling bearing.

7. The injection molding tool according to claim 4, wherein, the guide nut is rotatable.

8. The injection molding tool according to claim 4, wherein the guide nut is rotatable by a circumferential gear attached thereto.

9. The injection molding tool according to claim 5, wherein mounting of the rotatable screw core does not include a rolling bearing.

10. The injection molding tool according to claim 5, wherein mounting of the rotatable screw core does not include a rolling bearing.

11. The injection molding tool according to claim 5, wherein the guide nut is rotatable

12. The injection molding tool according to claim 5, wherein the guide nut is rotatable.

13. The injection molding tool according to claim 5, wherein the guide nut is rotatable.
